(19) United States
(12) Patent Application Publication
(10) Pub. No.: US 2021/0292625 A1
(43) Pub. Date: Sep. 23, 2021

(54) SHOT-PEENING METHOD

(71) Applicant: SAINT-GOBAIN CENTRE DE RECHERCHES ET D'ETUDES EUROPEEN, COURBEVOlE (FR)

(72) Inventors: Anne-Laure BEAUDONNET, ROBION (FR); Julien CABRERO, POITIERS (FR); Benjamin Gilbert Robert LEVY, MARSEILLE (FR)

(21) Appl. No.: 17/261,165

(22) PCT Filed: Jul. 19, 2019
(86) PCT No.: PCT/EP2019/069555

§ 371 Date: Jan. 18, 2021

(30) Foreign Application Priority Data
Jul. 20, 2018 (FR) 1856745

(51) Int. Cl. C09K 3/14; C04B 35/488; C04B 35/626; C04B 35/64; B24C 1/10; B24C 11/00

(52) U.S. Cl. CPC C09K 3/1418; C04B 2235/6567; C04B 35/6264; C04B 35/6261; C04B 35/62695; C04B 35/64; B24C 1/10; B24C 11/00; C04B 2235/3246; C04B 2235/3229; C04B 2235/3225; C04B 2235/3217; C04B 2235/3418; C04B 2235/3262; C04B 2235/3208; C04B 2235/6562; C04B 35/4885

(57) ABSTRACT

Shot-peening method. Projecting a powder onto a surface. The powder includes sintered particles, more than 95 wt % of the particles are beads. The powder has, in wt % based on the oxides: —ZrO₂ partially stabilized with CeO₂ and Y₂O₃: balance to 100%, CeO₂ and Y₂O₃ present, in mol % according to the sum of ZrO₂, CeO₂ and Y₂O₃, CeO₂: 2.5-11 mol % and Y₂O₃: 0.5-2 mol %, —Al₂O₃; 3-50%—additive chosen from CaO, manganese oxides, ZnO, praseodymium oxides, SrO, copper oxides, 0.2-6% Nd₂O₃, BaO, iron oxides, and mixtures thereof: CaO being less than 2%, —elements other than ZrO₂, CeO₂, Y₂O₃, Al₂O₃, CaO, manganese oxides, ZnO, praseodymium oxides, ≤5% SrO, copper oxides, Nd₂O₃, BaO, and iron oxides: manganese oxides, praseodymium oxides, copper oxides and iron oxides being expressed as MnO, Pr₆O₁₁, CuO and Fe₂O₃, respectively, and a relative density greater than 95%.

### TECHNICAL FIELD

The invention relates to a shot-blasting process, in particular for the treatment of metal surfaces, for example made of steel, and to a powder which can be used in such a process.

### PRIOR ART

Shot blasting consists in projecting particles, generally beads, at high speed onto the component to be treated. The particles are made of materials with a hardness suited to the objective to be achieved. Steel beads or ceramic beads are commonly used.

Shot blasting can be employed for cleaning purposes, for example for the removal of rust (descaling), to modify the surface appearance of a component, in particular the roughness, the brightness or the shininess (cosmetic finishing), or to create compressive prestresses, or “residual stresses”, on the surface of a component (shot peening). Such prestresses make it possible to improve the properties of the component treated by surface hardening (work hardening). For example, they can make it possible to increase fatigue strength or corrosion resistance. Shot peening is thus conventionally employed, for example, to improve the operating performance of highly stressed parts, such as, for example, automobile parts, in particular pinions or transmission shafts, springs, torsion bars, connecting rods or crankshafts.

EP 2 231 363 describes a shot-peening process which makes it possible to efficiently create high compressive prestresses at the surface and in the surface layer of the treated part. This process comprises an operation of projecting particles exhibiting a bulk density of between 4.0 and 5.0 g/cm³. EP 2 231 363 teaches that, when the bulk density of the projected particles is greater than 5 g/cm³, the thickness of the surface layer affected by the shot blasting decreases.

Finally, the use in shot blasting of a media powder comprising partially stabilized zirconia, passing through a sieve with an opening of less than or equal to 2.36 mm, exhibiting a relative density of greater than or equal to 95%, and the particles of which exhibit a mean grain size of less than 1 μm and a hardness Hv of greater than 1000, is known from U.S. Pat. No. 5,409,415.

The projection of ceramic beads does not always make it possible to create compressive prestresses over a sufficient thickness. There exists a need for a shot-blasting process which makes it possible to efficiently create high compressive prestresses in a surface layer of the treated part.

One aim of the invention is to meet this need, at least partially.

### SUMMARY OF THE INVENTION

The invention provides a shot-blasting powder consisting of sintered particles, more than 95% by weight of the particles being beads, the powder exhibiting
a chemical analysis such that, as percentages by weight based on the oxides,
   ZrO₂ partially stabilized with CeO₂ and Y₂O₃: remainder to 100%, CeO₂ and Y₂O₃ being present in amounts such that, as molar percentage based on the sum of ZrO₂, CeO₂ and Y₂O₃,
      CeO₂: 2.5-11 mol % and
      Y₂O₃: 0.5-2 mol %,
   Al₂O₃: 3-50%
   additive chosen from CaO, manganese oxides, ZnO, praseodymium oxides, SrO, copper oxides, Nd₂O₃, BaO, iron oxides and their mixtures: 0.2-6% the CaO content being less than 2%,
   elements other than ZrO₂, CeO₂, Y₂O₃, Al₂O₃, CaO, manganese oxides, ZnO, praseodymium oxides, SrO, copper oxides, Nd₂O₃, BaO and iron oxides: ≤5%
the manganese oxides, the praseodymium oxides, the copper oxides and the iron oxides being expressed in the MnO, Pr₆O₁₁, CuO and Fe₂O₃ form respectively, and
a relative density of greater than 95%.

As will become apparent in more detail in the continuation of the description, surprisingly, the projection of such a powder makes it possible to obtain high compressive prestresses in a surface layer of the treated part.

A powder according to the invention can also comprise one or more of the following optional characteristics:
the additive is chosen from CaO, manganese oxides, ZnO, SrO, BaO and their mixtures;
the additive comprises CaO, the CaO content being greater than 0.2%, and a second additive compound chosen from manganese oxides, ZnO, SrO, BaO and their mixtures, the content of said second additive compound being greater than 0.1%, as percentages by weight based on the oxides of the powder;
the additive is a mixture of one or more manganese oxide(s) and CaO, the content of manganese oxide(s), expressed in the MnO form, being greater than 0.1% and less than 4% and the content of CaO being greater than 0.2% and less than 4%, as percentage by weight based on the oxides;
the content of “elements other than ZrO₂, CeO₂, Y₂O₃, Al₂O₃, CaO, manganese oxides, ZnO, praseodymium oxides, SrO, copper oxides, Nd₂O₃, BaO and iron oxides” is less than 2.0%, as percentage by weight based on the oxides;
the SiO₂ content is less than 4%, preferably less than 3%, preferably less than 2%, preferably less than 1.5%, preferably less than 1%, indeed even less than 0.5%, as percentage by weight based on the oxides;
the Al₂O₃ content is greater than 8% and less than 40%, as percentage by weight based on the oxides;
the molar content of Y₂O₃ is greater than 0.7% and less than 1.7%, as molar percentages based on the sum of ZrO₂, CeO₂ and Y₂O₃;
the relative density of the powder is greater than 98%.

In a specific embodiment, a powder according to the invention can also comprise one or more of the following optional characteristics:
the molar content of CeO₂ is between 8.0% and 10.0%, as molar percentages based on the sum of ZrO₂, CeO₂ and Y₂O₃;
the Al₂O₃ content is greater than 15% and less than 35%, and/or the SiO₂ content is less than 1.5%, as percentage by weight based on the oxides.

In another specific embodiment, a powder according to the invention can also comprise one or more of the following optional characteristics:
the molar content of CeO₂ is greater than 3% and less than 6.0%, as molar percentages based on the sum of ZrO₂, CeO₂ and Y₂O₃;
the Al₂O₃ content is greater than 5% and less than 19%, as percentage by weight based on the oxides.

The invention also relates to a shot-blasting process comprising a stage of projecting a powder onto a surface of a component to be treated, said powder being in accordance with the invention.

The process can also comprise one or more of the following optional characteristics:
the particles are projected at a speed of greater than 40 m/s, along a direction forming a projection angle with the surface to be treated of greater than 45°;
the component to be treated is chosen from the group formed by an automobile component, a component of an aeronautical vehicle, a piece of jewelry, a watch, a bracelet, a necklace, a ring, a brooch, a tie pin, a handbag, an item of furniture, a household utensil, a handle, a button, a veneer, a visible part of an item of consumer goods equipment, a part of a spectacle frame, an article of kitchenware and a frame.

The invention finally relates to the use of a process according to the invention for creating compressive prestresses in the surface layer of a component to be treated, the projected powder exhibiting a median size D₅₀ of greater than 40 μm and less than 1200 μm, or for modifying the appearance of the surface of a component to be treated, the projected powder exhibiting a median size D₅₀ of less than 200 μm.

### Definitions

The term “bead” is understood to mean a particle exhibiting a sphericity, that is to say a ratio of its smallest Feret diameter to its greatest Feret diameter, of greater than or equal to 0.75, whatever the way by which this sphericity was obtained.

The term “powder of beads” is understood to mean a powder comprising more than 95% by weight of beads.

The term “sintered bead” is understood to mean a bead obtained by mixing appropriate starting materials and then green shaping this mixture and firing the resulting green bead at a temperature and for a time sufficient to obtain the sintering of this green bead. A sintered bead is made up of “grains” bonded to one another during the sintering.

The “size” of a particle of a powder is conventionally its dimension measured by means of a laser particle sizer.

The references to 50 (denoted D₅₀) and 99.5 (denoted D_{99.5}) “percentiles” refer to the sizes of particles or beads corresponding to the percentages equal to 50% and 99.5% respectively, by weight, on the cumulative particle size distribution curve, of the sizes of particles, respectively of beads, of the powder, said sizes of particles, respectively of beads, being classified in ascending order. According to this definition, 99.5% by weight of the particles or beads of the powder thus have a size less than D_{99.5} and 0.5% of the particles or beads, by weight, exhibit a size of greater than or equal to D_{99.5.} The percentiles are determined using a particle size distribution produced using a laser particle sizer.

The 50 percentile is called the “median size” of a powder of particles or of beads. The median size thus divides the particles, respectively the beads, of the powder into first and second populations equal in weight, these first and second populations comprising only particles, respectively beads, exhibiting a size of greater than or equal to, or respectively less than, the median size.

The term “maximum size” of a powder of particles or of beads refers to the 99.5 percentile.

The “median sphericity” of a powder divides the particles of this powder into first and second populations equal in weight, these first and second populations comprising only particles exhibiting a sphericity of greater than or equal to, or respectively less than, the median sphericity.

For the sake of clarity, the terms “ZrO₂”, “HfO₂” and “Al₂O₃” are used to denote the oxides of Zr, Hf and Al in the composition, respectively, and “zirconia”, “hafnia” and “corundum” to denote crystalline phases of these oxides consisting of ZrO₂, of HfO₂ and of Al₂O₃, respectively. These oxides can, however, also be present in other phases. In particular, Al₂O₃ can be present in combination with other oxides in elongated aluminous nodules.

When reference is made to ZrO₂, this should be understood as (ZrO₂+HfO₂), with HfO₂≤5%, preferably HfO₂≤3%, preferably HfO₂≤2%. This is because a little HfO₂, chemically indissociable from ZrO₂ and exhibiting similar properties, is always naturally present in zirconia sources. HfO₂ is then not considered as an impurity.

A total content of several oxides, for example ZrO₂+SiO₂+Al₂O₃+CeO₂+Y₂O₃, does not imply that each of said oxides is present, even if, in one embodiment, each of said oxides is present.

The term “absolute density” of a powder is understood to mean the absolute density conventionally calculated using a law of mixtures, from a chemical analysis of said powder, by considering that all of the oxides of yttrium and cerium stabilize zirconia, and without taking into account additives and impurities. The absolute density of zirconia partially stabilized with Y₂O₃ and CeO₂ is calculated according to the teaching of the document “Phase transformation and lattice constants of zirconia solid solutions in the system Y₂O₃—CeO₂ —ZrO₂”, Urabe et al., Materials Science Forum, Vols. 34-36 (1988), pp 147-152.

The term “relative density” of a powder is understood to mean the ratio equal to the apparent density divided by the absolute density, expressed as a percentage.

The term “bulk density” of a powder is understood to mean the ratio of the weight of powder to the cumulative volume of the particles of the powder, thus including the closed porosity located inside these particles.

The “coverage” is the ratio of the surface area of the impacted component, that is to say the component modified by the impact of the projected particles, to the total surface area toward which the powder of particles is projected, that is to say the surface area of the component exposed to the jet of the projected particles. The coverage is expressed as percentages. The coverage is thus less than 100% as long as there exist, within the surface which the jet of particles crosses, areas not modified by the impacts of these particles.

The “degree of coverage”, expressed as percentage, is the ratio of the treatment time to the treatment time which makes it possible to obtain a coverage equal to 98%. Thus a degree of coverage equal to 200% expresses the fact that the duration of the treatment is equal to twice that necessary to achieve a coverage equal to 98%.

A “precursor” of an oxide is a constituent which is transformed into said oxide during the manufacture of a powder according to the invention.

The term “mean size” of the compact grains of a sintered product refers to the dimension measured according to a “Mean Linear Intercept” method. A measurement method of this type is described in the standard ASTM E1382. The measurement can be carried out on a cut of the product, as described in the examples. A person skilled in the art knows how to increase the mean size of the grains by increasing the median size of the particulate mixture in stage i′) and/or by increasing the sintering temperature in stage ii′) and/or by increasing the sintering time in stage vii′).

An “elongated aluminous nodule” is a structure exhibiting a form factor of greater than or equal to 2.5 and consisting of an aluminous grain or of several adjacent aluminous grains, that is to say ones in contact. A person skilled in the art knows how to increase the amount of elongated aluminous nodules by increasing the amount of additive in the particulate mixture in stage i′) and/or by increasing the sintering temperature in stage ii′), in particular up to 1500° C., and/or by increasing the amount of Al₂O₃ in the particulate mixture in stage i′).

An “aluminous” grain is a grain containing aluminum and additive, in which Al₂O₃+additive >40% (cumulative content of additive and of aluminum, the contents of aluminum and of additive being expressed in the oxide form, >40%), as percentage by weight of the grain.

A “grain” is a particle agglomerated with other particles in a sintered product. The terms “partially stabilized zirconia grains” and “alumina grains” are understood to mean grains comprising more than 90% of partially stabilized zirconia and of alumina, respectively.

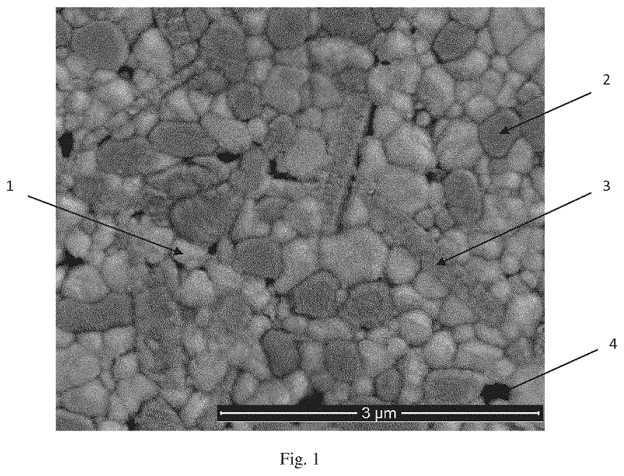

The term “form factor of a grain or of an elongated aluminous nodule”, denoted “F”, refers to the ratio of the greatest dimension of the grain or of the elongated aluminous nodule, or “length”, to the greatest dimension measured perpendicular to the direction of said greatest dimension, or “width”. These dimensions are measured in a plane of observation of a polished section of the bead, conventionally on electron microscopy images of this section (see FIG. 1).

The term “mean length” of the elongated aluminous nodules refers to the mean of the lengths of the elongated aluminous nodules, said lengths being measured in a plane of observation of a polished section of the bead, conventionally on electron microscopy images of this section.

A grain exhibiting a form factor of less than 2.5 is called a “compact grain”. “To contain”, “to comprise” or “to exhibit” should not be interpreted in a limiting manner.

Unless otherwise mentioned, the percentages used to characterize a composition always refer to percentages by weight based on the oxides.

### BRIEF DESCRIPTION OF THE FIGURES

Other characteristics and advantages of the invention will become more clearly apparent on reading the detailed description which will follow and on examining the appended drawing, in which FIG. 1 represents a photograph of a polished section of a sintered bead of the powder of example 3, according to the invention, obtained after sintering at a temperature of 1460° C., this bead having undergone, after polishing, a thermal attack at 1360° C. for 30 minutes to reveal the grain boundaries.

### DETAILED DESCRIPTION

### Process for the Manufacture of the Powder

In order to manufacture a powder of sintered beads according to the invention, it is possible to proceed according to a process comprising the following stages:
i′) optionally, grinding one or more powders of starting materials providing constituents of the beads to be manufactured and/or precursors of these constituents, preferably by cogrinding, and metering said powders of optionally ground starting materials, so as to obtain a particulate mixture exhibiting a median size of less than 0.6 μm,
ii′) optionally, drying said particulate mixture,
iii′) preparation of a starting charge from said particulate mixture, which is optionally dried, so that the powder obtained on conclusion of stage vii′) exhibits a composition in accordance with the invention,
iv′) shaping of the starting charge in the form of green beads, so that more than 95% by weight of the particles of the powder obtained on conclusion of stage vii′) are beads,
v′) optionally, washing,
vi′) optionally, drying,
vii′) sintering, so as to obtain a powder of sintered beads,
viii′) optionally, particle size selection.

In stage i′), the powders of starting materials can be ground individually or, preferably, coground, if their mixing in proportions suitable for the manufacture of ceramic beads exhibiting the desired composition does not result in a particulate mixture exhibiting a median size less than 0.6 μm. This grinding can be a wet grinding.

Preferably, a grinding or a cogrinding is carried out so that the median size of said particulate mixture is less than 0.5 μm, preferably less than 0.4 μm.

Preferably, the powders used, in particular the ZrO₂, Al₂O₃, Y₂C₃, CeO₂ and additive powders, each exhibit a median size of less than 5 μm, indeed even of less than 3 μm, of less than 1 μm, of less than 0.8 μm, of less than 0.7 μm, preferably of less than 0.6 μm, preferably of less than 0.5 μm, preferably of less than 0.3 μm, indeed even of less than 0.2 μm. Advantageously, when each of these powders exhibits a median size of less than 0.6 μm, preferably of less than 0.5 μm, preferably of less than 0.4 μm, stage i′) is optional.

Preferably, the zirconia powder used exhibits a specific area, calculated by the BET method, of greater than 5 m²/g, preferably of greater than 8 m²/g, preferably of greater than 10 m²/g, and less than 30 m²/g. Advantageously, the sintering temperature in stage vii′) is reduced, and the grinding in stage i′), generally in suspension, is thereby facilitated.

In stage ii′), which is optional, the particulate mixture is dried, for example in an oven or by atomization, in particular if it has been obtained by wet grinding. Preferably, the temperature and/or the duration of the drying stage are adapted so that the residual moisture content of the particulate mixture is less than 2%, indeed even less than 1.5%.

In stage iii′), the preparation is carried out, preferably at ambient temperature, of a starting charge suitable for the shaping process of stage iv′), as is well known to a person skilled in the art. The charge is adapted so that the composition of the powder obtained on conclusion of stage vii′) is in accordance with the invention. For this purpose, it comprises ZrO₂, Al₂O₃, CeO₂ and Y₂O₃ powders and, if appropriate, one or more powders of CaO and/or of a manganese oxide and/or of ZnO and/or of a praseodymium oxide and/or of SrO and/or of a copper oxide and/or of Nd₂O₃ and/or of BaO and/or of an iron oxide.

These powders can also be replaced, at least partially, with powders of precursors of these oxides, introduced in equivalent amounts.

The powders providing the oxides or the precursors are preferably chosen so that the total content of impurities, that is to say of elements not deliberately introduced, is less than 4%, preferably less than 3%, preferably less at 2%, as percentage by weight based on the oxides.

In a specific embodiment, Y₂O₃ is introduced, at least in part, in the form of a zirconia partially stabilized with yttrium oxide.

In one embodiment, CeO₂ is introduced, at least in part, in the form of a zirconia partially stabilized with cerium oxide, indeed even stabilized with cerium oxide.

Preferably, the manganese oxide is chosen from MnO, Mn₃O₄ and their mixtures.

Preferably, the praseodymium oxide is Pr₆O₁₁.

Preferably, the copper oxide is CuO.

Preferably, the iron oxide is chosen from FeO, Fe₂O₃ and their mixtures.

The starting charge can comprise, in addition to the particulate mixture, a solvent, preferably water, the amount of which is suitable for the shaping method of stage iv′). The starting charge then consists of the particulate mixture and of the solvent.

In stage iv′), any conventional shaping process known for the manufacture of sintered beads can be employed. Mention may be made, among these processes, of:
granulation processes, for example employing granulators, fluidized bed granulators or granulating disks,
gelling processes,
injection molding or extrusion processes, and
pressing processes.

Forming can in particular result from a gelation process. For this purpose, a solvent, preferably water, is added to the starting charge so as to produce a suspension. The suspension preferably exhibits a solids content by weight of between 50% and 70%. The suspension can also comprise one or more of the following constituents:
a dispersant, in a proportion of 0% to 10%, as percentage by weight based on the solids;
a surface tension modifier, in a proportion of 0% to 3%, as percentage by weight based on the solids;
a gelling agent, or “gelation agent”, in a proportion of 0% to 2%, as percentage by weight based on the solids.

The dispersants, surface tension modifiers and gelling agents are well known to a person skilled in the art.

The particulate mixture is preferably added to a mixture of water and of dispersants/deflocculants, in a ball mill. After agitation, water in which a gelling agent was dissolved beforehand is added so as to obtain a suspension.

In a gelation process, drops of the suspension described above are obtained by flow of the suspension through a calibrated orifice. The drops exiting from the orifice fall into a bath of a gelation solution (electrolyte suitable for reacting with the gelling agent) where they harden after having regained a substantially spherical shape.

In stage v′), which is optional, the green beads obtained during the preceding stage are washed, for example with water.

In stage vi′), which is optional, the green beads, which are optionally washed, are dried, for example in an oven.

In stage vii′), the green beads, which are optionally washed and/or dried, are sintered. Preferably, the sintering is carried out under air, preferably in an electric furnace, preferably at atmospheric pressure.

Preferably, the sintering time is greater than 1 hour, greater than 2 hours, and/or less than 10 hours, less than 7 hours, or less than 5 hours. Preferably, the sintering time is between 2 and 5 hours.

The sintering in stage vii′) is carried out at a temperature of greater than 1300° C. and preferably of less than 1600° C., preferably of less than 1550° C., preferably of less than 1500° C.

If, before sintering, the beads do not contain a Mn, Zn, Cu, Pr, Nd, Sr, La, Ba or Fe compound, that is to say if the additive in the beads of the powder is CaO, the sintering temperature is greater than 1400° C., preferably greater than 1425° C.

If the molar content of CeO₂ of the beads of the powder which are obtained at the end of stage vii′) is between 10% and 11%, the sintering temperature is greater than 1400° C.

The sintering temperature preferably increases as the amount of Al₂O₃ increases.

In stage vii′), which is optional, the powder obtained undergoes a particle size sorting, for example by sieving and/or by air separation, configured in order to obtain a particle size distribution suitable for the shot blasting process envisaged.

### Powder

Preferably, a powder of beads according to the invention comprises, as percentage by weight, more than 96%, preferably more than 97%, preferably more than 98%, preferably more than 99%, preferably substantially 100%, of beads.

Preferably, more than 80%, preferably more than 85%, preferably more than 90%, preferably more than 95%, preferably more than 97%, by weight of the beads of the powder each exhibit a sphericity of greater than 0.80, preferably of greater than 0.85, preferably of greater than 0.90, preferably of greater than 0.92, preferably of greater than 0.94, preferably of greater than 0.95.

The median sphericity of the powder of beads is preferably greater than 0.80, preferably greater than 0.85, preferably greater than 0.90, preferably greater than 0.92, preferably greater than 0.94, preferably greater than 0.95, preferably greater than 0.97, preferably greater than 0.98.

The powder of beads preferably exhibits a maximum size of less than 2 mm, preferably of less than 1.8 mm, preferably of less than 1.5 mm and preferably a median size of greater than 40 μm and less than 1200 μm.

In one embodiment, the powder of beads exhibits a median size D₅₀ of greater than 80 μm, preferably of greater than 100 μm, preferably of greater than 150 μm, preferably of greater than 200 μm, preferably of greater than 400 μm and/or of less than 1000 μm, preferably of less than 800 μm. This embodiment is particularly well suited for a shot peening.

In one embodiment, the powder of beads exhibits a median size D₅₀ of less than 200 μm, preferably of less than 150 μm. This embodiment is particularly well suited for a shot blasting aimed at modifying the surface appearance of a component (cosmetic finishing).

The powder preferably exhibits a relative density of greater than 96%, preferably of greater than 97%, preferably of greater than 98%, preferably of greater than 99%.

The powder preferably exhibits a bulk density of greater than 5.0 g/cm³, preferably of greater than 5.1 g/cm³, and/or of less than 6.0 g/cm³, preferably of less than 5.9 g/cm³, preferably of less than 5.8 g/cm³. The difference in composition of the particles compared to those described in EP 2 231 363 advantageously makes it possible, with bulk densities of greater than 5.0 g/cm³, to obtain high compressive prestresses in the surface layer of the treated component for depths of greater than or equal to 150 μm.

The beads preferably exhibit a hardness of greater than 900 HV_{(0.5/15)}, preferably of greater than 1000 HV_{(0.5/15)}, preferably of greater than 1100 HV_{(0.5/15)}, and/or preferably of less than 1400 HV_{(0.5/15)}.

In one embodiment, the beads of the powder exhibit a polished surface. Advantageously, the treated component exhibits better fatigue behavior with respect to a cyclic stress.

Preferably, the powder consists of oxides for more than 95%, preferably for more than 97%, preferably for more than 99%, of its weight.

Preferably, each bead of the powder consists of oxides for more than 95%, preferably for more than 97%, preferably for more than 99%, of its weight.

The presence, in the starting charge, of CaO, and/or of a manganese oxide, and/or of ZnO, and/or of a praseodymium oxide, and/or of SrO, and/or of a copper oxide, and/or of Nd₂O₃, and/or of BaO, and/or of an iron oxide and/or of precursors of these oxides advantageously makes it possible to increase the amount of elongated aluminous nodules contained in the sintered beads.

The inventors have noted the presence of a specific microstructure in the sintered products according to the invention.

As represented in FIG. 1, said microstructure is characterized by the presence of compact grains of partially stabilized zirconia 1, of compact grains of alumina 2, of elongated aluminous nodules 3, which may be present in the form of substantially rectilinear rods, and also of pores 4. The mean length of the elongated aluminous nodules is typically greater than 1 μm and/or less than 20 μm. The compact grains typically exhibit a mean size of less than 3 μm and/or of greater than 0.1 μm.

Typically, more than 90%, more than 95%, indeed even more than 98% or 100%, of the weight of the zirconia exists in the form of compact zirconia grains.

CeO₂ and Y₂O₃ serve to stabilize the zirconia but can also be present outside it.

The inventors have observed that the elongated aluminous nodules consist substantially, depending on the additive, of a phase of hibonite type and/or of a phase of magnetoplumbite type.

A powder according to the invention can in particular exhibit one or more of the following composition characteristics:
the powder exhibits an Al₂O₃ content of greater than 5%, preferably of greater than 8%, preferably of greater than 10% and/or of less than 55%, preferably of less than 50%, preferably of less than 40%, preferably of less than 35%, as percentage by weight based on the oxides of the powder;
the powder exhibits a Y₂O₃ content of less than 1.9%, preferably of less than 1.7%, preferably of less than 1.5% and/or preferably of greater than 0.7%, indeed even of greater than 0.8%, as molar percentage based on the sum of ZrO₂, CeO₂ and Y₂O₃ present in the powder;
the powder exhibits a CeO₂ content of less than 10.5%, preferably of less than 10.0%, preferably of less than 9.5% and/or preferably of greater than 3.0%, as molar percentage based on the sum of ZrO₂, CeO₂ and Y₂O₃ present in the powder;
the powder exhibits an additive chosen from CaO, manganese oxides, ZnO, SrO, BaO and their mixtures, preferably from CaO, manganese oxides and their mixtures;
the powder exhibits an additive content of greater than 0.3%, indeed even of greater than 0.4%, indeed even of greater than 0.5% and/or of less than 5%, indeed even of less than 4%, indeed even of less than 3%, indeed even of less than 2.5%, indeed even of less than 2%, indeed even of less than 1.5%, indeed even of less than 1%, as percentage by weight based on the oxides of the powder;
the additive of the powder comprises CaO, the CaO content being greater than 0.2%, indeed even greater than 0.3%, indeed even greater than 0.4%, indeed even greater than 0.5%, and/or less than 1.5%, preferably less than 1%, indeed even less than 0.8%, less than 0.6%, as percentage by weight based on the oxides of the powder;
the additive of the powder comprises:
   CaO, the CaO content being greater than 0.2%, indeed even greater than 0.3%, indeed even greater than 0.4%, indeed even greater than 0.5%, and/or less than 1.5%, preferably less than 1%, indeed even less than 0.8%, less than 0.6%, as percentage by weight based on the oxides of the powder, and
   a second additive compound chosen from manganese oxides, ZnO, SrO, BaO and their mixtures, in particular manganese oxides, the content of said second additive compound preferably being greater than 0.1%, preferably greater than 0.2% and/or less than 4.0%, preferably less than 3.5%, preferably less than 3.0%, preferably less than 2.5%, preferably less than 2.0%, preferably less than 1.5%, indeed even less than 1.0%, indeed even less than 0.8%, indeed even less than 0.6%, as percentage by weight based on the oxides of the powder;
in a preferred embodiment, the additive of the powder is a mixture of one or more manganese oxide(s) and of CaO, the content of manganese oxide(s), expressed in the MnO form, preferably being greater than 0.1%, preferably greater than 0.2% and/or preferably less than 4%, preferably less than 3.5%, preferably less than 3%, preferably less than 2.5%, preferably less than 2%, preferably less than 1.5%, indeed even less than 1%, indeed even less than 0.8%, indeed even less than 0.6%, and the CaO content preferably being greater than 0.2%, indeed even greater than 0.3%, indeed even greater than 0.4%, indeed even greater than 0.5% and/or less than 4%, preferably less than 3.5%, preferably less than 3.0%, preferably less than 2.5%, preferably less than 2.0%, preferably less than 1.5%, indeed even less than 1.0%, indeed even less than 0.8%, indeed even less than 0.6%, as percentage by weight based on the oxides of the powder;
the powder exhibits a content of “elements other than ZrO₂, CeO₂, Y₂O₃, Al₂O₃, CaO, manganese oxides, ZnO, praseodymium oxides, SrO, copper oxides, Nd₂O₃, BaO and iron oxides” of less than 4.0%, preferably of less than 3.0%, preferably of less than 2.0%, preferably of less than 1.0%, preferably of less than 0.8%, preferably of less than 0.5%, indeed even of less than 0.3%, as percentage by weight based on the oxides of the powder. In one embodiment, the “elements other than ZrO₂, CeO₂, Y₂O₃, Al₂O₃, CaO, manganese oxides, ZnO, praseodymium oxides, SrO, copper oxides, Nd₂O₃, BaO and iron oxides” are impurities;
preferably, more than 80%, preferably more than 85%, preferably more than 90%, preferably more than 95%, indeed even more than 97%, indeed even more than 99%, by number of the beads of the powder according to the invention exhibit elongated aluminous nodules;
preferably, the microstructure of the sintered beads of the powder according to the invention is such that:
   the mean size of the compact grains is less than 3 μm, preferably less than 2.5 μm, preferably less than 2 μm, indeed even less than 1.5 μm, indeed even less than 1 μm, indeed even less than 0.8 μm, and preferably greater than 0.1 μm, indeed even greater than 0.2 μm, and
   the mean length of the elongated aluminous nodules is less than 20 μm;
in a preferred embodiment, more than 95%, preferably more than 97%, preferably more than 99%, by number of the compact grains are grains of partially stabilized zirconia and/or grains consisting for more than 40% of their weight of Al₂O₃;
more than 30%, preferably more than 50%, preferably more than 60%, preferably more than 70%, preferably more than 80%, by number of the elongated aluminous nodules exhibit a form factor of greater than or equal to 3, indeed even of greater than or equal to 4;
more than 30%, more than 40%, more than 60%, more than 80%, more than 90%, by number of the elongated aluminous nodules exhibit a rectilinear general shape.

Preferably, the SiO₂ content is less than 4%, preferably less than 3%, preferably less than 2%, preferably less than 1.5%, preferably less than 1%, indeed even less than 0.5%, as percentage by weight based on the oxides. Advantageously, the resistance to crushing is thereby improved.

In a preferred first main embodiment, the powder exhibits one or more of the following optional additional characteristics:
the molar content of CeO₂ is less than 10.5%, preferably less than 10.0%, preferably less than 9.5%, and/or preferably greater than 3.0%, preferably greater than 4.0%, preferably greater than 6.0%, preferably greater than 7.0%, preferably greater than 7.5%, preferably greater than 8.0%, indeed even greater than 8.5%, as molar percentage based on the sum of ZrO₂, CeO₂ and Y₂O₃ present in the powder;
the molar content of Y₂O₃ is less than 1.9%, preferably less than 1.7%, preferably less than 1.5%, preferably less than 1.2% and/or greater than 0.7%, indeed even greater than 0.8%, as molar percentage based on the sum of ZrO₂, CeO₂ and Y₂O₃ present in the powder;
in a specific embodiment, said molar content of CeO₂ is between 8.5% and 9.5% and said molar content of Y₂O₃ is between 0.8% and 1.2%, as molar percentages based on the sum of ZrO₂, CeO₂ and Y₂O₃ present in the powder;
the Al₂O₃ content is greater than 5%, preferably greater than 8%, preferably greater than 10%, preferably greater than 15%, preferably greater than 20% and/or less than 45%, preferably than 40%, preferably than 35%, as percentage by weight based on the oxides of the powder;
preferably, the SiO₂ content is less than 1.5%, less than 1.0%, preferably less than 0.7%, preferably less than 0.5%, as percentage by weight based on the oxides of the powder;
the beads of the powder are obtained by sintering at a temperature of greater than or equal to 1320° C., of greater than 1400° C., of greater than 1425° C. and/or of less than 1550° C.;
preferably, the mean size of all of the partially stabilized zirconia grains and of the alumina grains of the beads of the powder is less than 3 μm, preferably less than 2.5 μm, indeed even less than 2 μm, indeed even less than 1.5 μm, indeed even less than 1 μm, indeed even less than 0.8 μm, and preferably greater than 0.1 μm;
more than 80%, more than 90%, indeed even substantially 100%, by number of the elongated aluminous nodules of the beads of the powder exhibit a rectilinear general shape;
the elongated aluminous nodules of the beads of the powder comprise the element cerium (Ce).

Preferably, in this preferred first main embodiment, the beads exhibit the following characteristics:
the molar content of CeO₂ is less than 10.5%, preferably less than 10.0%, preferably less than 9.5%, and/or preferably greater than 3.0%, preferably greater than 4.0%, preferably greater than 6.0%, preferably greater than 7.0%, preferably greater than 7.5%, preferably greater than 8.0%, indeed even greater than 8.5%, as molar percentage based on the sum of ZrO₂, CeO₂ and Y₂O₃ present in the powder, and
the molar content of Y₂O₃ is less than 1.9%, preferably less than 1.7%, preferably less than 1.5%, preferably less than 1.2% and/or greater than 0.7%, indeed even greater than 0.8%, as molar percentage based on the sum of ZrO₂, CeO₂ and Y₂O₃ present in the powder, and
the Al₂O₃ content is greater than 5%, preferably greater than 8%, preferably greater than 10%, preferably greater than 15%, preferably greater than 20% and/or less than 45%, preferably than 40%, preferably than 35%, as percentage by weight based on the oxides of the powder, and
the SiO₂ content is less than 1.5%, less than 1.0%, preferably less than 0.7%, preferably less than 0.5%, as percentage by weight based on the oxides of the powder, and
the additive is a mixture of one or more manganese oxide(s) and of CaO, the content of manganese oxide(s), expressed in the MnO form, being greater than 0.1%, preferably greater than 0.2% and/or preferably less than 4%, preferably less than 3.5%, preferably less than 3%, preferably less than 2.5%, preferably less than 2%, preferably less than 1.5%, indeed even less than 1%, indeed even less than 0.8%, indeed even less than 0.6%, and the CaO content preferably being greater than 0.2%, indeed even greater than 0.3%, indeed even greater than 0.4%, indeed even greater than 0.5% and/or less than 4%, preferably less than 3.5%, preferably less than 3.0%, preferably less than 2.5%, preferably less than 2.0%, preferably less than 1.5%, indeed even less than 1.0%, indeed even less than 0.8%, indeed even less than 0.6%, as percentage by weight based on the oxides of the powder, and
the content of elements other than ZrO₂, CeO₂, Y₂O₃, Al₂O₃, CaO, manganese oxides, ZnO, praseodymium oxides, SrO, copper oxides, Nd₂O₃, BaO and iron oxides is less than 4.0%, preferably less than 3.0%, preferably less than 2.0%, preferably less than 1.0%, preferably less than 0.8%, preferably less than 0.5%, indeed even less than 0.3%, as percentage by weight based on the oxides of the powder.

In a preferred second main embodiment, the powder exhibits one or more of the following optional additional characteristics:
the mean size of the grains of the beads of the powder exhibiting a form factor of less than 2.5 μm is less than 1.5 μm, preferably less than 1 μm, preferably less than 0.5 μm and/or preferably greater than 0.1 μm, preferably greater than 0.2 μm;
in a preferred embodiment, more than 95%, preferably more than 97%, preferably more than 99%, by number of the grains of the beads of the powder exhibiting a form factor of less than 2.5 are grains of partially stabilized zirconia and/or grains consisting for more than 40% of their weight of Al₂O₃;
the mean length of the elongated aluminous nodules of the beads of the powder is less than 18 μm, preferably less than 15 μm, indeed even less than 10 μm and/or greater than 1 μm, preferably greater than 2 μm, preferably greater than 5 μm;
more than 50%, preferably more than 60%, preferably more than 70%, preferably more than 80%, by number of the elongated aluminous nodules of the beads of the powder exhibit a form factor of greater than or equal to 3, indeed even of greater than or equal to 4; more than 30%, more than 40%, more than 60%, more than 80%, more than 90%, by number of the elongated aluminous nodules of the beads of the powder exhibit a rectilinear general shape;
the molar content of Y₂O₃ is preferably less than 1.9%, preferably less than 1.7%, preferably less than 1.5% and/or preferably greater than 0.6%, preferably greater than 0.7%, preferably greater than 0.8%, preferably greater than 1.0%, as molar percentage based on the sum of ZrO₂, CeO₂ and Y₂O₃ present in the powder;
the molar content of CeO₂ is preferably less than 6.5%, preferably less than 6.0%, preferably less than 5.5%, preferably less than 5.0%, preferably less than 4.5%, preferably less than 4.2%, preferably less than 4.0%, preferably less than 3.8% and/or greater than 3.0%, as molar percentage based on the sum of ZrO₂, CeO₂ and Y₂O₃ present in the powder;
the Al₂O₃ content is preferably less than 19%, preferably less than 16% and/or preferably greater than 5%, preferably greater than 7%, preferably greater than 9%, preferably greater than 11%, preferably greater than 12%, preferably greater than 13%, as percentage by weight based on the oxides.

Preferably, in this preferred second main embodiment, the beads exhibit the following characteristics:
the molar content of Y₂O₃ is preferably less than 1.9%, preferably less than 1.7%, preferably less than 1.5% and/or preferably greater than 0.6%, preferably greater than 0.7%, preferably greater than 0.8%, preferably greater than 1.0%, as molar percentage based on the sum of ZrO₂, CeO₂ and Y₂O₃ present in the powder, and
the molar content of CeO₂ is preferably less than 6.5%, preferably less than 6%, preferably less than 5.5%, preferably less than 5.0%, preferably less than 4.5%, preferably less than 4.2%, preferably less than 4.0%, preferably less than 3.8% and/or greater than 3.0%, as molar percentage based on the sum of ZrO₂, CeO₂ and Y₂O₃ present in the powder, and
the Al₂O₃ content is greater than 5%, preferably greater than 7%, preferably greater than 9%, preferably greater than 11%, preferably greater than 12%, preferably greater than 13% and less than 19%, preferably less than 16%, as percentage by weight based on the oxides of the powder, and
the additive is a mixture of one or more manganese oxide(s) and of CaO, the content of manganese oxide(s), expressed in the MnO form, being greater than 0.1%, preferably greater than 0.2% and/or preferably less than 4%, preferably less than 3.5%, preferably less than 3%, preferably less than 2.5%, preferably less than 2%, preferably less than 1.5%, indeed even less than 1%, indeed even less than 0.8%, indeed even less than 0.6%, and the CaO content preferably being greater than 0.2%, indeed even greater than 0.3%, indeed even greater than 0.4%, indeed even greater than 0.5% and/or less than 4%, preferably less than 3.5%, preferably less than 3.0%, preferably less than 2.5%, preferably less than 2.0%, preferably less than 1.5%, indeed even less than 1.0%, indeed even less than 0.8%, indeed even less than 0.6%, as percentage by weight based on the oxides of the powder, and
the content of elements other than ZrO₂, CeO₂, Y₂O₃, Al₂O₃, CaO, manganese oxides, ZnO, praseodymium oxides, SrO, copper oxides, Nd₂O₃, BaO and iron oxides is less than 4.0%, preferably less than 3.0%, preferably less than 2.0%, preferably less than 1.0%, preferably less than 0.8%, preferably less than 0.5%, indeed even less than 0.3%, as percentage by weight based on the oxides of the powder.

In a preferred embodiment, more than 80%, preferably more than 85%, preferably more than 90%, preferably more than 95%, by weight of the beads of the powder each exhibit one or more of the characteristics described above.

### Shot-Blasting Process

All the known techniques of shot blasting by projection can be employed to project a powder according to the invention.

Preferably, no metal particles are projected, neither before nor after the projection of the powder according to the invention.

In one embodiment, only a powder according to the invention, and possibly exhibiting one or more of the abovementioned optional characteristics, in particular those of the two main embodiments, is projected, preferably several times.

Preferably, the projection is carried out by means of a compressed air shot-blasting machine, preferably of venturi effect or direct pressure type, preferably of direct pressure type, or by means of a turbine shot-blasting machine.

Preferably, the particles are projected at a speed of greater than 40 m/s, preferably of greater than 48 m/s, indeed even of greater than 50 m/s, indeed even of greater than 55 m/s. Conventionally, this speed is measured at the outlet of the nozzle.

More preferably, the particles are projected along a direction forming a projection angle with the surface to be treated, the projection angle, that is to say the angle between the surface to be treated and said direction (the axis of the jet of the projected beads), being preferably greater than 45°, preferably greater than 50°.

The particles are projected by passing through a nozzle arranged at a distance, called the “projection distance”, from the surface to be treated, said projection distance being preferably greater than 5 cm, preferably greater than 10 cm and/or preferably less than 30 cm, preferably less than 25 cm.

The projection nozzle of the shot-blasting machine preferably exhibits a diameter of greater than 6 mm, preferably of greater than 7 mm and/or of less than 15 mm, preferably of less than 12 mm.

The particles are projected onto the surface by being carried by a fluid, preferably air, the excess pressure (additional pressure beyond atmospheric pressure) of which is preferably greater than 0.5 bar, preferably greater than 1 bar, preferably greater than 2 bar and/or preferably less than 7 bar, preferably less than 6 bar.

Preferably, the process includes suction, preferably during the projection stage.

The particles are projected with a degree of coverage preferably of greater than 100%, preferably of greater than 120%, indeed even of greater than 150% and/or preferably of less than 300%, preferably of less than 250%, preferably of less than 200%.

The surface to be treated can undergo, before treatment by projection, a pretreatment, for example a polishing, for example of mirror type. In one embodiment, the surface to be treated does not comprise a coating. In one embodiment, the surface to be treated is made of a metallic material, preferably in the form of a metal or of a metal alloy, preferably made of steel, aluminum or titanium.

The surface to be treated can be in particular a surface of an automobile component and in particular be chosen from a pinion, a transmission shaft, a spring, a torsion bar, a connecting rod and a crankshaft.

The surface to be treated can be in particular a surface of a component of an aeronautical vehicle and in particular be chosen from a turbine blade, a landing gear, a pinion, a transmission shaft, a spring, a torsion bar, a connecting rod and a crankshaft.

In one embodiment, the surface to be treated is a surface of a component chosen from the group formed by a piece of jewelry, a watch, a bracelet, a necklace, a ring, a brooch, a tie pin, a handbag, an item of furniture, a household utensil, a handle, a button, a veneer, a visible part of an item of consumer goods equipment, a part of a spectacle frame, an article of kitchenware and a frame.

### Examples

The following nonlimiting examples are given for the purpose of illustrating the invention.

### Measurement Protocols

To determine the sphericity of a bead, the smallest and greatest Feret diameters are measured on a Camsizer XT sold by Horiba.

The bulk density of a powder was measured using an Accupyc 1330 automatic helium pycnometer.

The microhardness was measured using a Vickers Zwick 3212 microdurometer. The values are obtained from Vickers indentations at a load 0.5 kg, said load being applied for a time equal to 15 seconds (HV_{(0.5/15)}).

The chemical analysis of the powders was determined by X-ray fluorescence.

The particle size analysis was carried out using a Camsizer XT laser particle sizer sold by Horiba.

For the powders of beads of examples 2 to 4, the form factor of the elongated aluminous nodules and of the compact grains, as well as the mean length of the elongated aluminous nodules, are measured on images obtained by backscattered electron scanning electron microscopy of sections of sintered beads, said sections having been polished beforehand until a mirror quality is obtained and then thermally etched to reveal the grain boundaries, in a cycle exhibiting a temperature rise rate equal to 100° C./h, up to a stationary-phase temperature equal to 1360° C., maintained for 30 minutes, and a fall in temperature by natural cooling. The magnification used for taking the images is chosen so as to display between 2 and 4 elongated aluminous nodules on an image. 10 beads were withdrawn at random and 5 images per bead were taken.

The mean size of the compact grains of the sintered beads of the powder was measured by the “Mean Linear Intercept” method. A method of this type is described in the standard ASTM E1382. According to this standard, analysis lines are drawn on images of the beads, then, along each analysis line, the lengths, called “intercepts”, between two consecutive compact grain boundaries cutting said analysis line are measured. The analysis lines are determined so as not to cut an elongated aluminous nodule.

The mean length “ ” of the intercepts “I” is subsequently determined.

The mean size “d” of the compact grains of the sintered beads of the powder is given by the relationship: d=1.56×1′. This formula results from formula (13) of “Average Grain Size in Polycrystalline Ceramics”, M. I. Mendelson, J. Am. Cerm. Soc., Vol. 52, No. 8, pp 443-446.

### Powders Tested

The powder of example 1, outside the invention, is a powder of beads which are obtained by electrofusion, the particles of which have been sieved so as to recover the beads passing through a sieve of square mesh with an opening equal to 850 μm and not passing through a sieve of square mesh with an opening equal to 600 μm, said sieving being carried out on an AS 200 sieving machine sold by Retsch.

The powder of example 2, according to the invention, is a powder of beads, the particles of which have been sieved so as to recover the particles passing through a sieve of square mesh with an opening equal to 850 μm and not passing through a sieve of square mesh with an opening equal to 600 μm, said sieving being carried out on an AS 200 sieving machine sold by Retsch.

This powder was manufactured from a source of zirconia (specific area of the order of 8 m²/g; median size <5 μm), from a source of CeO₂ (median size <10 μm), from a source of Y₂O₃ (median size <20 μm), from a source of alumina (median size <5 μm), from a source of manganese oxides, mainly in the Mn₃O₄ form (D₉₀ of less than 44 μm) and also containing MnO. The purity of the sources of zirconia and of CeO₂ was greater than 99%. The purity of the source of manganese oxides, expressed in the MnO form, was greater than 88%. These powders were mixed and then coground in a wet medium until a mixture exhibiting a fine particle size (median size <0.3 μm) was obtained. The mixture was subsequently dried.

An aqueous suspension comprising, as percentages by weight of the solids, 7.5% of a dispersant of polyacrylic acid type, 1% of a deflocculant of carbonic acid ester type (viscosity stabilizer) and 1% of a gelling agent, namely a polysaccharide of the family of the alginates, was subsequently prepared from this mixture.

A ball mill was used for this preparation so as to obtain a suspension which is satisfactorily homogeneous. A solution containing the gelling agent was first formed. The dried mixture resulting from the cogrinding and the dispersant were successively added to water. The solution containing the gelling agent was subsequently added. The mixture thus obtained was stirred for 8 hours. Then the deflocculant was added and the mixture was stirred for 0.5 hour. After checking the size of the particles (median size of less than 0.3 μm), water was added in a predetermined amount in order to obtain an aqueous suspension with a solids content of 61% and a viscosity, measured with a Brookfield viscometer, of less than 8500 centipoises. The pH of the suspension was then approximately 9.

The suspension was forced through a calibrated hole and at a flow rate making it possible to obtain, after sintering, beads of between approximately 0.6 mm and 0.85 mm in the context of this example. The suspension drops fell into a gelation bath based on an electrolyte, a divalent or trivalent cation salt, which reacts with the gelling agent. The green beads were collected, washed to remove excess reactants, then dried at 90° C. to remove moisture. The beads were subsequently transferred to a sintering furnace where they were brought, at a rate of 100° C./h, up to a sintering temperature equal to 1460° C. At the end of a stationary phase of 3 hours at the sintering temperature, the temperature was lowered by natural cooling.

The powders of examples 3 and 4, according to the invention, are powders of beads, the particles of which were sieved so as to recover the particles passing through a sieve of square mesh with an opening equal to 850 μm and not passing through a sieve of square mesh with an opening equal to 600 μm, said sieving being carried out on an AS 200 sieving machine sold by Retsch.

The powders of beads of examples 3 and 4 were manufactured according to the same process as that used for the powder of beads of example 2, the amounts of powders of zirconia, of CeO₂, of Y₂O₃, of manganese oxides and of alumina in the starting charge being adapted in order to obtain the chemical analysis described in table 1.

The powders of examples 1 to 4 exhibit the characteristics shown in the following table 1.

TABLE 1

| | Examples | 1 (*) | 2 | 3 | 4 |
|---|---|---|---|---|---|
| Chemical analysis (as % by weight | ZrO₂ | 63 | 63 | 77 | 49.9 |
| based on the oxides) | SiO₂ | 7.6 | 0.2 | 0.05 | 0.05 |
| | Al₂O₃ | 5 | 24.5 | 14.8 | 40.2 |
| | Y₂O₃ | 3.8 | 1.3 | 1.75 | 1.11 |
| | CeO₂ | 19.7 | 8.6 | 4.36 | 6.79 |
| | Manganese oxide expressed as MnO | <0.02 | 0.50 | 0.40 | 0.50 |
| | CaO | <0.02 | 0.42 | 0.51 | 0.46 |
| | impurities | 0.87 | 1.48 | 1.13 | 0.99 |
| Molar content, based on the sum | ZrO₂ | 79.6 | 90.2 | 95 | 90.1 |
| ZrO₂ + Y₂O₃ + CeO₂ | Y₂O₃ | 2.6 | 1 | 1.2 | 1.1 |
| (molar %) | CeO₂ | 17.8 | 8.8 | 3.8 | 8.8 |
| Particle size characteristics | D₅₀ (μm) | 734 | 740 | 690 | 724 |
| | Median sphericity | 0.87 | 0.89 | 0.96 | 0.93 |
| Other physical characteristics | Bulk density (g/cm³) | 5.33 | 5.35 | 5.62 | 4.84 |
| | Relative density (%) | >99.7 | 99 | 99 | 96 |
| | Hardness HV_{(0.5/1.5)} | 984 | 1315 | 1228 | 1277 |

(*): outside the invention

The beads of the powder of example 2 exhibit a microstructure comprising compact grains exhibiting a mean size equal to 0.4 μm and elongated aluminous nodules exhibiting a mean length equal to 1.5 μm.

The beads of the powder of example 3 exhibit a microstructure comprising compact grains exhibiting a mean size equal to 0.5 μm and elongated aluminous nodules exhibiting a mean length equal to 10.4 μm.

The beads of the powder of example 4 exhibit a microstructure comprising compact grains exhibiting a mean size equal to 0.5 μm and elongated aluminous nodules exhibiting a mean length equal to 2.9 μm.

An amount of 100 g of each powder was subsequently projected, with recirculation, on a surface to be treated made of XC65 steel, by means of a Venturi-effect gun fitted with a projection nozzle of 8 mm in diameter, arranged at 150 mm from the surface to be treated, with a projection angle of 85° and at an excess pressure equal to 5 bar. Projection was continued until a degree of coverage equal to 125% was obtained.

The compressive prestresses in the treated surface were subsequently measured by X-ray diffraction with a Siemens D₅₀₀ device from the analysis of the mean deformation of the crystallographic planes as a function of their orientation.

### Results

The results obtained are summarized in the following table 2.

TABLE 2

| | Compressive prestress measured at a depth | | |
|---|---|---|---|
| | equal to | | |
| | 150 μm (MPa) | 175 μm (MPa) | 200 μm (MPa) |
| Example 1 (*) | 350 | 180 | 30 |
| Example 2 | 470 | 300 | 100 |
| Improvement in the | +34.3 | +66.7 | +233.3 |
| compressive prestress | | | |
| measured example | | | |
| 2/example 1 (%) | | | |
| Example 3 | 457 | 255 | 65 |
| Example 4 | 457 | 255 | 83 |
| Improvement in the | +30.6 | +41.8 | +116.7 |
| compressive prestress | | | |
| measured example | | | |
| 3/example 1 (%) | | | |
| Improvement in the | +30.6 | +41.8 | +177.8 |
| compressive prestress | | | |
| measured example | | | |
| 4/example 1 (%) | | | |

(*): outside the invention

A comparison of example 2, according to the invention, and of example 1 shows an improvement in the compressive prestress measured at a depth equal to 150 μm equal to 34.3%, said prestress being equal to 350 MPa for example 1 and equal to 470 MPa for example 2.

The improvement in the compressive prestress of an example, here example 2, with respect to a reference, in the present case example 1, is equal to (compressive prestress measured for the example—compressive prestress measured for the reference)/(compressive prestress measured for the example), expressed as percentages. The same is true for the compressive prestresses measured at a depth equal to 175 μm and to 200 μm, the improvement being equal to 66.7% and 233.3%, respectively.

A comparison of example 3, according to the invention, and of example 1 shows an improvement in the compressive prestress measured at a depth equal to 150 μm equal to 30.6%, said prestress being equal to 457 MPa for example 3.

A comparison of example 4, according to the invention, and of example 1 shows an improvement in the compressive prestress measured at a depth equal to 150 μm equal to 30.6%, said prestress being equal to 457 MPa for example 4.

The same is true for the compressive prestresses measured at a depth equal to 175 μm and to 200 μm, the improvement being equal to 41.8% and 116.7%, respectively, for the powder of beads of example 3, and equal to 41.8% and 177.8%, respectively, for the powder of beads of example 4.

As is now clearly apparent, the invention thus provides a shot-blasting process which makes it possible to create higher compressive prestresses in a surface layer of the component treated, in particular at a depth of greater than or equal to 150 μm.

Of course, the present invention is not limited to the described and represented embodiments provided by way of illustrative and nonlimiting examples. In particular, the beads might exhibit other compositions or other particle sizes than those described above and other gelation systems might also be suitable for manufacturing a powder of sintered beads according to the invention. Thus, U.S. Pat. No. 5,466,400, FR 2 842 438 and U.S. Pat. No. 4,063,856 describe applicable sol-gel processes. FR 2 842 438 and U.S. Pat. No. 4,063,856 use a gelation system similar to that described above (based on alginate), whereas U.S. Pat. No. 5,466,400 describes a very different gelation system.

The process described in US 2009/0036291 and the processes for the formation of beads by pressing or by granulation can also be envisaged.

1. A shot-blasting process comprising a stage of projection of a powder onto a surface of a component to be treated, said powder consisting of sintered particles, more than 95% by weight of the particles being beads, the powder exhibiting
a chemical analysis such that, as percentages by weight based on the oxides,
ZrO₂ partially stabilized with CeO₂ and Y₂O₃: remainder to 100%, CeO₂ and Y₂O₃ being present in amounts such that, as molar percentage based on the sum of ZrO₂, CeO₂ and Y₂O₃,
CeO₂: 2.5-11 mol % and
Y₂O₃: 0.5-2 mol %,
Al₂O₃: 3-50%
additive chosen from CaO, manganese oxides, ZnO, praseodymium oxides, SrO, copper oxides, Nd₂O₃, BaO, iron oxides and their mixtures: 0.2-6% the CaO content being less than 2%,
elements other than ZrO₂, CeO₂, Y₂O₃, Al₂O₃, CaO, manganese oxides, ZnO, praseodymium oxides, SrO, copper oxides, Nd₂O₃, BaO and iron oxides: ≤5%
the manganese oxides, the praseodymium oxides, the copper oxides and the iron oxides being expressed in the MnO, Pr₆O₁₁, CuO and Fe₂O₃ form respectively, and
a relative density of greater than 95%.

2. The process as claimed in claim 1, in which the additive is chosen from CaO; manganese oxides, ZnO, SrO; BaO and their mixtures.

3. The process as claimed in claim 2, in which the additive comprises:
CaO, the CaO content in said powder being greater than 0.2%, and
a second additive compound chosen from manganese oxides, ZnO, SrO, BaO and their mixtures, the content of said second additive compound in said powder being greater than 0.1%,
as percentages by weight based on the oxides of the powder.

4. The process as claimed in claim 3, in which the additive is a mixture of one or more manganese oxide(s) and of CaO, the content of manganese oxide(s), expressed in the MnO form, in said powder being greater than 0.1% and less than 4% and the CaO content being greater than 0.2% and less than 4%, as percentage by weight based on the oxides.

5. The process as claimed in claim 1, in which the content of “elements other than ZrO₂, CeO₂, Y₂O₃, Al₂O₃, CaO, manganese oxides, ZnO, praseodymium oxides, SrO, copper oxides, Nd₂O₃, BaO and iron oxides” in said powder is less than 2.0%, as percentage by weight based on the oxides.

6. The process as claimed in claim 1, in which the Al₂O₃ content in said powder is greater than 8% and less than 40%, as percentage by weight based on the oxides.

7. The process as claimed in claim 1, in which the molar content of Y₂O₃ in said powder is greater than 0.7% and less than 1.7%, as molar percentages based on the sum of ZrO₂, CeO₂ and Y₂O₃.

8. The process as claimed in claim 1, in which the molar content of CeO₂ in said powder is between 8.0% and 10.0%, as molar percentages based on the sum of ZrO₂, CeO₂ and Y₂O₃.

9. The process as claimed in claim 1, in which the Al₂O₃ content in said powder is greater than 15% and less than 35%, and/or the SiO₂ content is less than 1.5%, as percentage by weight based on the oxides.

10. The process as claimed in claim 1, in which the molar content of CeO₂ in said powder is greater than 3% and less than 6.0%, as molar percentages based on the sum of ZrO₂, CeO₂ and Y₂O₃.

11. The process as claimed in claim 10, in which the Al₂O₃ content in said powder is greater than 5% and less than 19%, as percentage by weight based on the oxides.

12. The process as claimed in claim 1, said powder exhibiting a relative density of greater than 98%.

13. The process as claimed in claim 1, in which the particles are projected at a speed of greater than 40 m/s, along a direction forming a projection angle with the surface to be treated of greater than 45°.

14. The process as claimed in claim 1, in which the component to be treated is chosen from the group formed by an automobile component, a component of an aeronautical vehicle, a piece of jewelry, a watch, a bracelet, a necklace, a ring, a brooch, a tie pin, a handbag, an item of furniture, a household utensil, a handle, a button, a veneer, a visible part of an item of consumer goods equipment, a part of a spectacle frame, an article of kitchenware and a frame.

15. The use of a process as claimed in claim 1, for creating compressive prestresses in the surface layer of a component to be treated, the projected powder exhibiting a median size D₅₀ of greater than 40 μm and less than 1200 μm, or for modifying the appearance of the surface of a component to be treated, the projected powder exhibiting a median size D₅₀ of less than 200 μm.
